(19) United States
(12) Patent Application Publication
(10) Pub. No.: US 2024/0316945 A1
(43) Pub. Date: Sep. 26, 2024

(54) PRINT HEAD INK SUPPLY BOOST

(71) Applicant: DOMINO UK LIMITED, Cambridge, Cambridgeshire (GB)

(72) Inventors: Stephan MORGENTHALER, Cambridge (GB); Christian NYDEGGER, Cambridge (GB)

(73) Assignee: DOMINO UK LIMITED, Cambridge, Cambridgeshire (GB)

(21) Appl. No.: 18/579,012

(22) PCT Filed: Jul. 15, 2022
(86) PCT No.: PCT/EP22/69968

§ 371 Date: Jan. 12, 2024

(30) Foreign Application Priority Data
Jul. 15, 2021 (GB) 2110219.9

(51) Int. Cl. B41J 2/175; B41J 2/18

(52) U.S. Cl. CPC B41J 2/17596; B41J 2/18

(57) ABSTRACT

An ink jet printer ink circuit (10) has an ink feed (18), an ink return (20), a pump (22) and a print head (24), the print head having ink inlet (26) and outlet (28) ports and ink jetting nozzles (30). When printing at normal levels of ink demand, the pump (22) causes ink to flow from the ink feed (18) into the print head (24) through the ink inlet port (26), and out of the print head (24) through the ink outlet port (28) to the ink return (20). The ink circuit (10) has print head ink supply boost means (22. 23) operable, when printing at high levels of ink demand, to cause ink to flow into the print head (24) through the ink outlet port (28) at the same time as ink flows into the print head (24) through the ink inlet port (26). Also a printer including such an ink circuit and a method of boosting a print head ink supply in such an ink circuit.

### FIELD OF THE INVENTION

This invention relates to an ink circuit for an ink jet printer, to a printer including such an ink circuit, and to a method of boosting a print head ink supply in an ink circuit for an ink jet printer.

### BACKGROUND TO THE INVENTION

Ink jet print heads having ink inlet and outlet ports and ink jetting nozzles are known. In use of such a print head, ink is pumped from a reservoir into the ink inlet port and some of this ink is ejected from the ink jetting nozzles, the remainder being pumped out of the ink outlet port for return to the reservoir. The ink is circulated in this manner to prevent the ink from drying in the print head, which could block the ink jetting nozzles, and, where the ink includes a pigment, to prevent sedimentation of the pigment.

US Patent Application Publication No. US 2009/0109267, for example, shows a printer that includes such a print head.

It has been found that when printing at high levels of ink demand, for example when printing densely coloured images at high speed, occasionally such print heads suffer from ink starvation, which is where insufficient ink reaches the jetting nozzles for satisfactory printing. Ink starvation manifests itself as missing areas of a printed image or areas of the printed image that are less densely coloured than required.

### SUMMARY OF THE INVENTION

According to a first aspect of the invention, there is provided an ink circuit for an ink jet printer, the ink circuit comprising an ink feed, an ink return, a pump and a print head, the print head having ink inlet and outlet ports and ink jetting nozzles, the ink circuit being arranged such that, when printing at normal levels of ink demand, the pump causes ink to flow from the ink feed into the print head through the ink inlet port, some of the ink flowing into the print head through the ink inlet port is ejected from the ink jetting nozzles and the remainder flows out of the print head through the ink outlet port to the ink return, wherein the ink circuit further comprises print head ink supply boost means operable, when printing at high levels of ink demand, to cause ink to flow into the print head through the ink outlet port at the same time as ink flows into the print head through the ink inlet port.

The invention can provide an ink circuit that can reduce a risk of ink starvation of the print head when printing at high levels of ink demand.

The print head ink supply boost means may, for example, comprise a further pump operable to cause ink to flow from the ink return into the print head through the ink outlet port.

The further pump may, for example, be a reversible pump operable in one direction when printing at normal levels of ink demand to cause ink to flow out of the print head through the ink outlet port to the ink return, and operable in the opposite direction when printing at high levels of ink demand to cause ink to flow from the ink return into the print head through the ink outlet port.

It is usual in an ink circuit for an ink jet printer to include between the ink feed and the ink inlet port of the print head a filter and a debubbler for preventing solid particles and bubbles from reaching the print head.

Where the print head ink supply boost means comprise the further pump operable to cause ink to flow from the ink return into the print head through the ink outlet port, another filter and another debubbler are required between the ink return and the ink outlet port of the print head, which increase the cost of manufacture of the ink circuit.

Alternatively, therefore, the print head ink supply boost means may, for example, comprise a valve selectably operable either to direct a flow of ink from the ink feed into the print head through the ink outlet port, or to direct the flow of ink out of the print head through the ink outlet port to the ink return.

In a preferred embodiment of the invention, however, the print head ink supply boost means comprise a drain tank in fluid communication with the ink outlet port of the print head, the drain tank receiving a flow of ink from the ink outlet port when a volume of ink ejected from the ink jetting nozzles is less than a volume of ink flowing into the print head through the ink inlet port, and the drain tank providing a flow of ink into the ink outlet port when the volume of ink ejected from the ink jetting nozzles exceeds a volume of ink flowing into the print head through the ink inlet port.

The drain tank may advantageously have a first opening in fluid communication with the ink return and a second opening in fluid communication with the ink outlet port of the print head.

The ink circuit may advantageously include a fill tank having a first opening in fluid communication with the ink feed and a second opening in fluid communication with the ink inlet port of the print head.

Where the ink circuit includes the drain and fill tanks, the drain and fill tanks are preferably closed to the atmosphere.

Where the drain and fill tanks are closed to the atmosphere, the ink circuit may advantageously include a valve in fluid communication with the drain tank and the fill tank.

The valve may advantageously be in fluid communication with a third opening in the drain tank and a third opening in the fill tank.

When open, the valve enables a flow of ink from the fill tank into the drain tank, which flow is in addition to the flow of ink from the fill tank into the drain tank through the print head. The valve enables ink to circulate in the ink circuit at a relatively high flow rate even when the print head is not being used for printing, which, where the ink includes a pigment, reduces a risk of sedimentation of the pigment.

Where the drain and fill tanks are closed to the atmosphere, in a preferred embodiment of the invention each tank is provided with a pressure sensor operable to measure a pressure inside the tank, the pump is a feed pump in fluid communication with the ink feed and the fill tank, the ink circuit further comprises a return pump in fluid communication with the drain tank and the ink return, and the ink circuit is operable to control the feed and return pumps in dependence upon the measured pressures inside the drain and fill tanks to maintain the pressures in the drain and fill tanks below atmospheric pressure and the pressure in the drain tank below the pressure in the fill tank.

In this way, the ink circuit ensures that ink does not leak from the jetting nozzles, that there is a flow of ink from the fill tank to the drain tank through the print head when the volume of ink ejected from the jetting nozzles is less than the volume of ink flowing into the print head through the ink inlet port, and that there is a flow of ink from the drain and fill tanks into the print head through the ink outlet and inlet ports, respectively, when the volume of ink ejected from the jetting nozzles is greater than the volume of ink flowing into the print head through the ink inlet port.

It is known in ink circuits that include print heads having ink inlet and outlet ports and ink jetting nozzles to include a heater for heating the ink that flows into the print heads through the ink inlet ports. Such heating of the ink may be required, for example, if a printer is used in a cold building, or if a viscosity of the ink at room temperature is too high for jetting by the ink jetting nozzles.

The ink circuit may advantageously include a heater for heating the ink that flows into the print head through the ink outlet port.

Where the ink circuit includes the drain and fill tanks, a single heater may advantageously be arranged between the drain and fill tanks to heat ink in both tanks.

At first sight, it may appear wasteful to heat the ink in the drain tank, given that, when printing at normal levels of ink demand, the ink in the drain tank will eventually flow from the drain tank to the ink return, whence the ink is typically returned to an unheated reservoir of ink.

However, this arrangement of the heater allows a simple and inexpensive construction of the heater, which would otherwise be required to identify when ink flows from the drain tank into the print head, and to heat the ink to the required temperature in the short time interval between the ink leaving the drain tank and entering the ink outlet port of the print head.

According to a second aspect of the invention, there is provided a printer including an ink circuit according to the first aspect of the invention.

According to a third aspect of the invention, there is provided a method of boosting a print head ink supply in an ink circuit for an ink jet printer, which ink circuit includes a print head that has ink inlet and outlet ports and ink jetting nozzles, the method comprising, when printing at normal levels of ink demand, causing ink to flow from an ink feed of the ink circuit into the print head through the ink inlet port, some of the ink flowing into the print head through the ink inlet port to be ejected from the ink jetting nozzles and the remainder to flow out of the print head through the ink outlet port to an ink return of the ink circuit, the method further comprising, when printing at high levels of ink demand, causing ink to flow into the print head through the ink outlet port at the same time as ink flows into the print head through the ink inlet port.

The method may advantageously comprise measuring pressures in drain and fill tanks in fluid communication, respectively, with the ink outlet and inlet ports of the print head, and controlling return and feed pumps in fluid communication, respectively, with the drain and fill tanks to maintain the pressures in the drain and fill tanks below atmospheric pressure and the pressure in the drain tank below the pressure in the fill tank.

The method may advantageously further comprise heating ink in the drain and fill tanks.

### BRIEF DESCRIPTION OF THE DRAWINGS

The invention will now be described, by way of example, with reference to the attached drawing figures, in which:

FIG. 1 is a simplified schematic diagram of an ink circuit in accordance with the first aspect of the invention;

FIG. 2 is a detail of the ink circuit of FIG. 1;

FIG. 3 is a schematic diagram of an ink jet printer in accordance with the second aspect of the invention; and

FIG. 4 is a flow chart of a method in accordance with the third aspect of the invention of boosting a print head ink supply in an ink circuit for an ink jet printer.

### DETAILED DESCRIPTION OF EMBODIMENTS

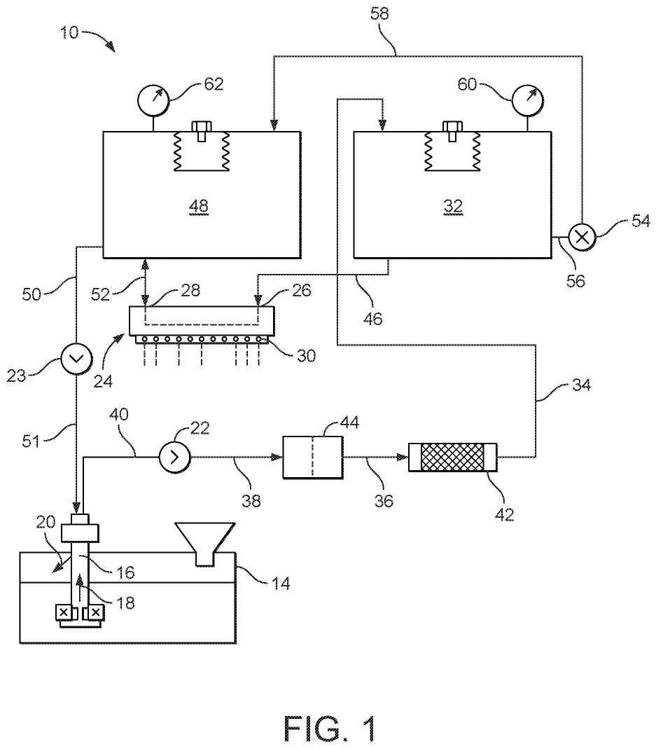

The ink circuit 10 of FIG. 1 includes an ink feed and an ink return constituted by a suction lance 16 that draws ink from an ink reservoir 14 into the ink feed (represented by the arrow 18) and discharges ink from the ink return (represented by the arrow 20) into the ink reservoir 14.

The ink circuit 10 also includes a feed pump 22 connected to the ink feed 18 of the suction lance 16, a return pump 23 connected to the ink return 20 of the suction lance 16, and an ink jet print head denoted generally by reference numeral 24 and having an ink inlet port 26, an ink outlet port 28 and ink jetting nozzles, one of which is denoted by reference numeral 30.

A fill tank 32 is in fluid communication with the ink feed 18 via a first opening in the top of the tank 32 and tubes 34, 36, 38 and 40, of which tube 34 connects the first opening to the output of a debubbler 42, tube 36 connects the input of the debubbler 42 to the output of a filter 44, tube 38 connects the input of the filter 44 to the output of the feed pump 22, and tube 40 connects the input of the feed pump 22 to the ink feed 18 of the suction lance 16.

The fill tank 32 is in fluid communication with the ink inlet port 26 of the print head 24 via a second opening in the bottom of the tank 32 and a tube 46, which connects the second opening to the ink inlet port 26.

A drain tank 48 is in fluid communication with the ink return 20 via a first opening at the bottom of a side wall of the drain tank 48 and tubes 50 and 51, of which tube 50 connects the first opening to the input of the return pump 23 and tube 51 connects the output of the return pump to the ink return 20 of the suction lance 16.

The drain tank 48 is in fluid communication with the ink outlet port 28 of the print head 24 via a second opening in the bottom of the tank 48 and a tube 52, which connects the second opening to the ink outlet port 28.

The ink circuit includes a valve 54 in fluid communication with the fill tank 32 via a third opening at the bottom of a side wall of the fill tank 32, which third opening is connected to the input of the valve 54 by a tube 56.

The valve 54 is also in fluid communication with the drain tank 48 via a third opening in the top of the drain tank 48, which third opening is connected to the output of the valve 54 by a tube 58.

When the print head 24 of the ink circuit 10 is printing, the valve 54 is kept closed. Ink circulates in the ink circuit from the reservoir 14 to the fill tank 32, through the print head 24 (from which some of the ink is ejected from the jetting nozzles), to the drain tank 48 and back to the reservoir 14.

When the print head of the ink circuit 10 is not printing, because no ink is ejected from the jetting nozzles, the flow of ink circulating in the ink circuit is restricted by the print head 24, which, where the ink includes a pigment, creates a risk of sedimentation of the pigment. The valve 54 is therefore opened, allowing ink to circulate relatively quickly from the reservoir 14 to the fill tank 32, from the fill tank 32 directly to the drain tank 48 through the valve 54, and from the drain tank 48 back to the reservoir 14, thereby reducing the risk of sedimentation.

The fill and drain tanks 32 and 48 are closed to the atmosphere and provided with respective pressure sensors 60 and 62, which measure the pressures inside the tanks.

Control electronics (not shown) monitor the pressures inside the fill and drain tanks 32 and 48 and control the speeds of the feed and return pumps 22 and 23 to maintain the pressures inside the fill and drain tanks 32 and 48 slightly below atmospheric pressure, to prevent ink from leaking from the jetting nozzles, and the pressure in the drain tank 48 slightly below the pressure in the fill tank 32, to ensure a flow of ink from the fill tank 32 through the print head 24 to the drain tank 48 when printing at normal levels of ink demand. In the embodiment shown in FIG. 1, the pressure in the fill tank 32 is maintained at −35 mbar and the pressure in the drain tank 48 is maintained at −55 mbar, both pressures being measured relative to atmospheric pressure.

When printing at low levels of ink demand the control electronics decrease the speed of the feed pump 22 and increase the speed of the return pump 23 to prevent the pressures in the fill and drain tanks 32 and 48 rising above the predetermined levels, which could otherwise cause ink to leak from the jetting nozzles. When printing at high levels of ink demand, the control electronics increase the speed of the feed pump 22 and decrease the speed of the return pump 23 to prevent the pressures in the fill and drain tanks 32 and 48 falling below the predetermined levels, which could otherwise cause ink starvation of the print head 24.

It will be appreciated that when printing at high levels of ink demand, the action of the jetting nozzles ejecting ink from the print head 24 reduces the pressure in the print head 24. When the pressure in the print head 24 becomes lower than the pressure in the drain tank 48, ink flows from the drain tank 48 into the print head 24 through the ink outlet port 28 to boost the supply of ink to the print head.

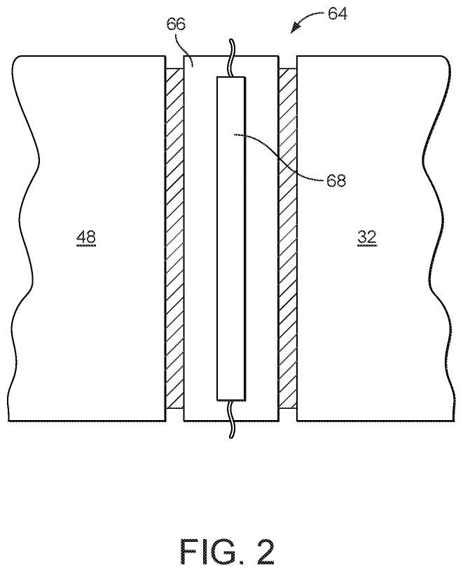

Turning to FIG. 2, this shows portions of the fill and drain tanks 32 and 48, and a heater denoted generally by reference numeral 64.

The heater 64 comprises an aluminium block 66 housing an electrical heating element 68. The aluminium block 66 is located between the fill and drain tanks 32 and 48 and abuts a side wall of each tank.

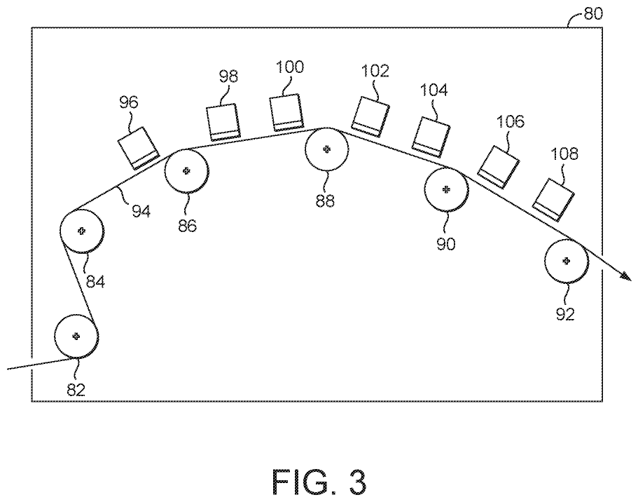

FIG. 3 is a schematic diagram of an ink jet printer 80 in which ink circuits such as that of FIG. 1 are intended for use.

The printer 80 includes a transport mechanism comprising rollers 82, 84, 86, 88, 90 and 92 for transporting a substrate web 94 through the printer, and print bars 96, 98, 100, 102, 104, 106 and 108 for jetting inks of different colours onto the substrate web 94 as it is transported through the printer.

Each print bar comprises multiple aligned print heads to enable ink to be jetted onto the substrate at any point across the substrate web during a single pass of the web. Each print head has an associated ink circuit as shown in FIG. 1 but all of the ink feeds and returns of the ink circuits of a print bar are connected to a single bulk ink reservoir.

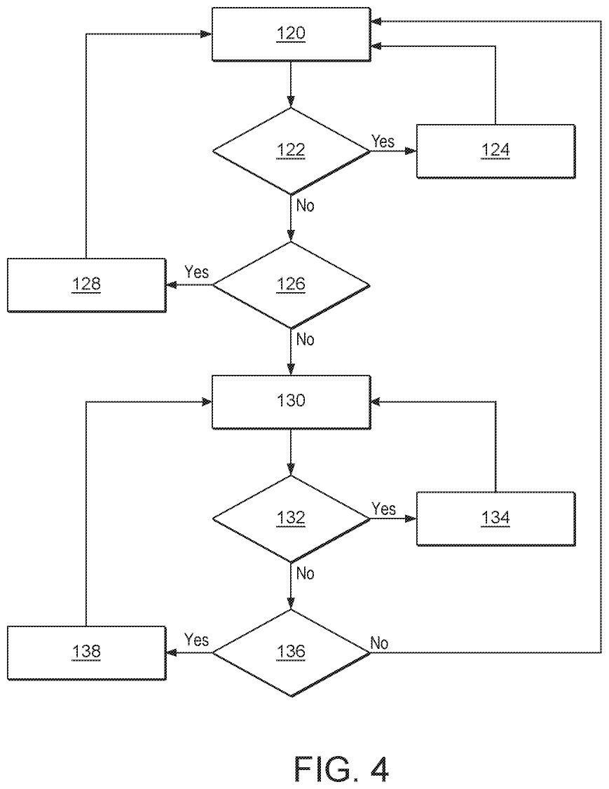

Turning finally to FIG. 4, in a method carried out by control electronics (not shown) of boosting a print head ink supply in an ink circuit for an ink jet printer, the method starts at step 120, at which a pressure in the fill tank 32 is measured using the pressure sensor 60. At step 122 a determination is made whether the pressure in the fill tank 32 is higher than a first predetermined pressure. If the pressure is higher, feed pump 22 is slowed at step 124 and the method returns to step 120 to measure the pressure in the fill tank 32.

If the pressure in the fill tank 32 is not higher than the first predetermined pressure, at step 126 a determination is made whether the pressure in the fill tank 32 is lower than the first predetermined pressure. If the pressure is lower, feed pump 22 is sped up at step 128 and the method returns to step 120 to measure the pressure in the fill tank 32. If the pressure is not lower, the pressure in the fill tank 32 is at the first predetermined pressure and the method proceeds to step 130.

At step 130 a pressure in the drain tank 48 is measured using the pressure sensor 62. At step 132 a determination is made whether the pressure in the drain tank 48 is higher than a second predetermined pressure. If the pressure is higher, return pump 23 is sped up at step 134 and the method returns to step 130 to measure the pressure in the drain tank 48.

If the pressure in the drain tank 48 is not higher than the second predetermined pressure, at step 136 a determination is made whether the pressure in the drain tank 48 is lower than the second predetermined pressure. If the pressure is lower, return pump 23 is slowed at step 138 and the method returns to step 130 to measure the pressure in the drain tank 48. If the pressure is not lower, the pressure in the drain tank 48 is at the second predetermined pressure and the method returns to step 120.

By maintaining the pressures in the fill and drain tanks 32 and 48 at the first and second predetermined pressures, respectively, namely at pressures slightly below atmospheric pressure and with the second predetermined pressure slightly lower than the first predetermined pressure, when printing at high levels of ink demand, ink is caused to flow into the print head through the ink outlet port at the same time as ink flows into the print head through the ink inlet port, thereby boosting the print head ink supply.

It will be appreciated that the above description relates only to selected embodiments of the invention, and that the invention encompasses other embodiments as defined by the claims.

1. An ink circuit for an ink jet printer, the ink circuit comprising an ink feed, an ink return, a pump and a print head, the print head having ink inlet and outlet ports and ink jetting nozzles, the ink circuit being arranged such that, when printing at normal levels of ink demand, the pump causes ink to flow from the ink feed into the print head through the ink inlet port, some of the ink flowing into the print head through the ink inlet port is ejected from the ink jetting nozzles and the remainder flows out of the print head through the ink outlet port to the ink return, wherein the ink circuit further comprises print head ink supply boost means operable, when printing at high levels of ink demand, to cause ink to flow into the print head through the ink outlet port at the same time as ink flows into the print head through the ink inlet port.

2. An ink circuit according to claim 1, wherein the print head ink supply boost means comprise a drain tank in fluid communication with the ink outlet port of the print head, the drain tank receiving a flow of ink from the ink outlet port when a volume of ink ejected from the ink jetting nozzles is less than a volume of ink flowing into the print head through the ink inlet port, and the drain tank providing a flow of ink into the ink outlet port when the volume of ink ejected from the ink jetting nozzles exceeds a volume of ink flowing into the print head through the ink inlet port.

3. An ink circuit according to claim 2, wherein the drain tank has a first opening in fluid communication with the ink return and a second opening in fluid communication with the ink outlet port of the print head.

4. An ink circuit according to claim 3, wherein the ink circuit includes a fill tank having a first opening in fluid communication with the ink feed and a second opening in fluid communication with the ink inlet port of the print head.

5. An ink circuit according to claim 4, wherein the drain and fill tanks are closed to the atmosphere.

6. An ink circuit according to claim 5, wherein the ink circuit includes a valve in fluid communication with the drain tank and the fill tank.

7. An ink circuit according to claim 5, wherein each tank is provided with a pressure sensor operable to measure a pressure inside the tank, the pump is a feed pump in fluid communication with the ink feed and the fill tank, the ink circuit further comprises a return pump in fluid communication with the drain tank and the ink return, and the ink circuit is operable to control the feed and return pumps in dependence upon the measured pressures inside the drain and fill tanks to maintain the pressures in the drain and fill tanks below atmospheric pressure and the pressure in the drain tank below the pressure in the fill tank.

8. An ink circuit according to claim 1, wherein the ink circuit includes a heater for heating the ink that flows into the print head through the ink outlet port.

9. An ink circuit according to claim 4, wherein the ink circuit includes a single heater is arranged between the drain and fill tanks to heat ink in both tanks.

10. A printer including an ink circuit according to claim 1.

11. A method of boosting a print head ink supply in an ink circuit for an ink jet printer, which ink circuit includes a print head that has ink inlet and outlet ports and ink jetting nozzles, the method comprising, when printing at normal levels of ink demand, causing ink to flow from an ink feed of the ink circuit into the print head through the ink inlet port, some of the ink flowing into the print head through the ink inlet port to be ejected from the ink jetting nozzles and the remainder to flow out of the print head through the ink outlet port to an ink return of the ink circuit, the method further comprising, when printing at high levels of ink demand, causing ink to flow into the print head through the ink outlet port at the same time as ink flows into the print head through the ink inlet port.

12. A method according to claim 11, wherein the method comprises measuring pressures in drain and fill tanks in fluid communication, respectively, with the ink outlet and inlet ports of the print head, and controlling return and feed pumps in fluid communication, respectively, with the drain and fill tanks to maintain the pressures in the drain and fill tanks below atmospheric pressure and the pressure in the drain tank below the pressure in the fill tank.

13. A method according to claim 12, wherein the method further comprises heating ink in the drain and fill tanks.
